(19) United States
(12) Patent Application Publication
(10) Pub. No.: US 2012/0310432 A1
(43) Pub. Date: Dec. 6, 2012

(54) ENERGY SUPPLY AND DEMAND CONTROL

(75) Inventors: Michael David De La Rue, Warszawa (PL); Abhinav Singh, Gold Coast (SG); Boby Kj, Kerala (IN); Maciej Gulak, Jozefoslaw (PL); Manuel Nakamurakare, Bellavista (PE); Marco Aurelio da Costa Soeima, Santo Antonio dos Cavaleiros (PT)

(73) Assignee: NOKIA SIEMENS NETWORKS OY, ESPOO (FI)

(21) Appl. No.: 13/151,484

(22) Filed: Jun. 2, 2011

(51) Int. Cl. G06F 1/32

(52) U.S. Cl. 700/295

(57) ABSTRACT

The present invention relates to Energy Supply and Demand Control. It is determined if energy demand is above a threshold and, if so, a location one or more mobile devices is determined, wherein said one or more mobile devices are associated with a premises. One or more corrective actions are triggered at the premises if the location of the one or more mobile devices is greater than a predefined distance from the premises.

The present invention relates to controlling energy supply and demand and, in particular, to controlling the energy supply to reduce demand.

Energy may be supplied to consumers where consumers may be private individuals, businesses, organisations, and so on. The energy supplied depends on the consumers needs, and may include one or more of gas, electricity, oil, and so on.

The demand for energy from the consumers is often variable and may be unpredictable. Energy consumption may have unexpected peaks or may have predictable patterns, such as roughly the same amount of energy is consumed at the same time each day or each week, an major event on television (e.g. a sporting event) may cause a spike in energy consumption during a break in the event or straight after the event.

With either unpredicted peaks or predicted peaks the demand for energy may be greater than the ability of the energy supplier to supply the energy, or the demand may be very close to the energy supply capability.

If this is the case, then energy shortages, energy cuts, energy blackouts may be experienced by the consumer which may affect the consumer's confidence in one energy supplier meaning the consumer may move their business to another energy supplier. This because energy is typically supplied by one or more energy suppliers where there may be several energy suppliers vying for consumers business.

Thus, there is a need to more efficiently or effectively control energy demands on the energy supply network. The present invention seeks to address, at least in part, some or all of the problems and disadvantages described above.

According to a first aspect of the present invention there is provided a method comprising the steps of: determining if energy demand is above a threshold; determining a location one or more mobile devices if said energy demand is above said threshold, wherein said one or more mobile devices are associated with a premises; and triggering one or more corrective actions at said premises if said location of said one or more mobile devices are greater than a predefined distance from said premises.

The method may be implemented by a server or any other computing device. The method enables an energy supplier to determine periods of high energy demand and trigger corrective actions if mobile devices associated with premises, where the premises are consumers of energy, are greater than a predetermined distance from the premises.

The energy demand may be based on one or both of a current energy demand and a predicted energy demand.

The step of triggering said one or more corrective actions is further based on one or more predefined first criteria. For example, based on the amount of energy demand, the distance between the mobile device and the premises, the type of premises (e.g. business, organisation, home, etc), and so on.

The method may further comprise the step of maintaining a database of said premises and said associated one or more mobile devices.

The step of determining if said energy demand is above said threshold may further comprise the steps of determining if said energy demand is above one or more different thresholds. Therefore, several thresholds may be implemented, for example, one threshold for home consumers, one for business consumers, different degrees of severity (e.g. how close the demand is to the ability to supply the energy), and so on.

The threshold may be a variable threshold.

The step of determining said location of one or more mobile devices further comprises the steps of identifying said one or more mobile devices based on one or more predefined second criteria.

The step of triggering said one or more corrective actions further comprises the step of transmitting a request to one or more devices at said premises wherein said request is to reduce energy consumption is said one or more devices.

A mobile device may be associated with one or more premises. For example, a mobile device may be associated with a home and with an office. One predefined criteria may be to determine, for example, based on the time of day and the day of the week whether the mobile device is to be considered in terms of the business premises and/or the home premises.

According to a second aspect of the present invention there is provided an apparatus comprising: a first processor adapted to determine if energy demand is above a threshold; a second processor adapted to determine a location one or more mobile devices if said energy demand is above said threshold, wherein said one or more mobile devices are associated with a premises; and a third processor adapted to trigger one or more corrective actions at said premises if said location of said one or more mobile devices are greater than a predefined distance from said premises.

According to a third aspect of the present invention there is provided an apparatus adapted to: determine if energy demand is above a threshold; determine a location one or more mobile devices if said energy demand is above said threshold, wherein said one or more mobile devices are associated with a premises; and trigger one or more corrective actions at said premises if said location of said one or more mobile devices are greater than a predefined distance from said premises.

The apparatus may be a server. The processors may be adapted to interact with inputs, outputs, memory, and so on in order to perform the necessary functions:

The first processor may be further adapted to determine if energy demand is above said threshold based on one or both of a current energy demand and a predicted energy demand.

The third processor may be further adapted to trigger said one or more corrective actions is further based on one or more predefined criteria.

The apparatus may further comprise a fourth processor adapted to maintain a database of said premises and said associated one or more mobile devices.

The first processor may be further adapted to determining if said energy demand is above one or more different thresholds.

The apparatus may further comprise a fifth processor adapted to identify said one or more mobile devices based on one or more predefined second criteria.

The apparatus may further comprise an output adapted to transmit a request to one or more devices at said premises wherein said request is to reduce energy consumption is said one or more devices.

The first processor through fifth processor may be the same processor, different processors or any combination thereof.

According to a fourth aspect of the present invention there is provided a computer program product comprising computer readable executable code for: determining if energy demand is above a threshold; determining a location one or more mobile devices if said energy demand is above said threshold, wherein said one or more mobile devices are associated with a premises; and triggering one or more corrective actions at said premises if said location of said one or more mobile devices are greater than a predefined distance from said premises.

The computer program product may further comprise computer readable executable code for performing any or all of the functions in accordance with the aspects of the invention.

Embodiments of the present invention will now be described, by way of example only, and with reference to the accompanying drawing, in which:

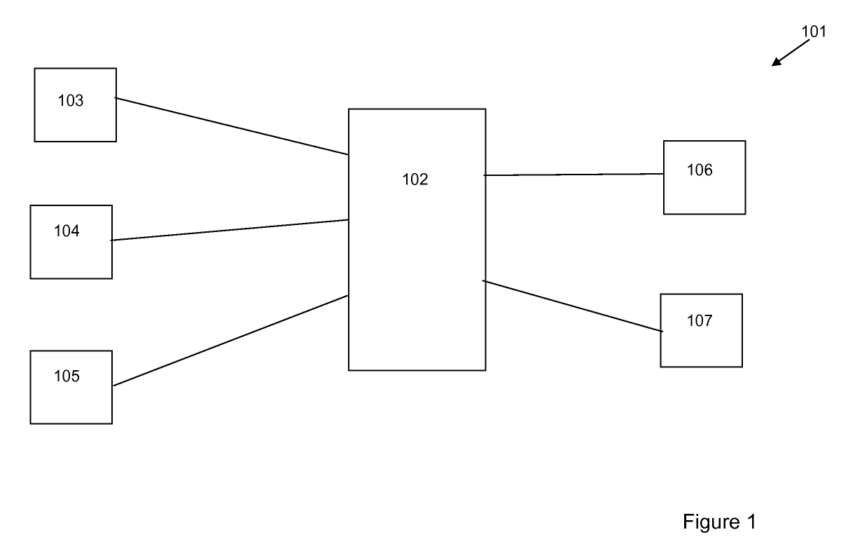

FIG. 1 shows a simplified block diagram of a system in accordance with many embodiments of the present invention.

With reference to FIG. 1, an energy supplier 102 monitors the demand for energy that the energy supplier supplies. The energy supplier 102 may monitor the demand for their energy, the energy demand, in real-time (e.g. as the energy demand varies). The energy supplier 102 may also perform some form of analysis in order to predict, to some degree of accuracy, the energy demands that will be placed on the energy supplier 102. For example, the energy supplier 102 may perform analysis on historical data to determine a predicted energy demand, may determine when certain events, e.g. sporting events will take place, and so on.

In order to be able to control energy demand on the energy supplier 102, the energy supplier 102 may offer consumers different rates depending on whether the consumer allows the energy supplier 102 to affect their energy consumption, for example, the energy supplier 102 may offer reduced rates if the consumer allows the energy supplier 102 to turn off one or more devices in the consumer premises when energy demand is peaking. Alternatively, the energy supplier 102 may simply affect the energy usage of the consumer at their premises if the energy demand is peaking.

However, the consumer would not appreciate their devices being turned off, turned down, or affected in any other way whilst they are using the devices. The energy supplier 102 may therefore lose the business from consumers if the energy demand control was not implemented effectively.

Thus, in many of the embodiments, the energy supplier 102 determines when the energy demand is above at least one threshold and, if so, identifies the location of one or more mobile devices 103, 104, 105, associated with premises 106, 107 of the consumer. Based in the identified location of the mobile devices 103, 104, 105 the energy supplier 102 determines if corrective actions at the premises 106, 107 can be taken in order to control the energy demand.

The mobile devices 103, 104, 105 may be any device that is location aware and can provide their location to the energy supplier 102. For example, the mobile device 103, 104, 105 may be a mobile telephone, a tablet, or a tag device provided to the consumers for the purpose of the energy demand control of many of the embodiments of the present invention.

A consumer may be an individual person or individual household (comprising two or more members) where the members of the household are provided with a tag device from the energy supplier 102 and/or the members of the household use mobile telephones as the mobile device 103, 104, 105. In this case the premises 106, 107 may be a house.

The consumer may be a business where the business employs one or more employees and each of the employees is provided with or uses a mobile device 103, 104, 105 such as a mobile telephone or a tag device from the energy supplier 102. In this case the premises may be an office building or an area of an office building.

As will be appreciated, the consumers may also be organisations, or any other party that consumes and pays for energy supply at least one premises.

If the mobile device 103, 104, 105 used to provide location data to the energy supplier 102 is a mobile telephone then the consumer may associate the one or more mobile telephones with one or more premises 106, 107.

The energy supplier 102 may maintain a database or other record of the premises 106, 107 of the consumers and the mobile devices 103, 104, 105 associated with each of the premises 106, 107.

The energy supplier 102 may determine when the energy demand exceeds at least one threshold. A single threshold for the energy demand may be implemented or multiple thresholds depending on the energy demand, and for example, may associate different premises to different thresholds.

The thresholds may be any thresholds predefined by the energy supplier 102. For example, a threshold may be when the demand exceeds a particular value, when demand is a particular percentage of the energy able to be supplied by the energy supplier 102. If multiple thresholds are used then the energy supplier 102 may associate or define that certain premises are included at one threshold (e.g. private houses) and other premises are included at another threshold (e.g. businesses) when determining the corrective actions to take to control energy demand. As will be appreciated any number of thresholds may be implemented and any premises may be associated with any of the thresholds.

When the energy supplier 102 determines that the energy demand exceeds a predefined threshold the energy supplier 102 identifies the location of one or more mobile devices 103, 104, 105 associated with the consumer premises 106, 107.

If the location of the mobile devices 103, 104, 105 are determined to be a predefined distance away from the associated premises 106, 107 then based on the locations of the mobile devices 103, 104, 105 the energy supplier 102 may take corrective actions at the premises 106, 107.

The location of mobile devices 103, 104, 105 may be determined in any one of a number of ways. For example, by receiving the Global Positioning System (GPS) location data for each mobile device 103, 104, 105, if the mobile devices 103, 104, 105 are mobile communication devices, e.g. mobile telephones, then the location or approximate location may be identified by the cell area of the mobile devices 103, 104, 105 and/or by a base station the mobile devices 103, 104, 105 are in communication with. The mobile devices 103, 104, 105 location may be determined using triangulation or by any other means available.

Based on the identified location of the mobile devices 103, 104, 105 corrective actions may be triggered by the energy supplier 102. For example, the energy supplier 102 may define one or more criteria the location of the mobile devices 103, 104, 105 must fulfil in order to trigger one or more corrective actions.

For example, if mobile device 103 corresponds to the only occupant of a private house, premises 106, then corrective actions at the premises 106 may be taken if the location of the mobile device 103 is determined to be more than a predefined distance away from the premises 106.

If premises 107 is an office and two people work at the office then each of the employees mobile devices 104, 105 locations will be identified. Then corrective actions may be triggered if the location of both employees mobile devices 104, 105 are more than a predefined distance from the premises 107. The distance from the premises 107 may be set at a different distance for each of the mobile devices 104, 105, for example, depending on the home of the employee.

The determination of the distance from the premises may be based on a calculation of the distance, a Geo-Fence, or any other means.

The energy supplier 102 may maintain a database or other record of the criteria that the mobile devices 103, 104, 105 associated with premises 106, 107 have to fulfil in order to trigger corrective actions at the premises 106, 107. As will be appreciated, any number or combination of criteria may be set by the energy supplier 102 for different mobile devices 103, 104, 105 and/or different premises 106, 107.

The corrective actions that may be triggered may be any corrective actions predefined by the energy supplier 102. The corrective actions may be maintained in a database or other structure. The corrective actions may be associated with the premises 106, 107 and one or more different or the same corrective actions may be triggered for the different premises 106, 107.

In the example that mobile device 103 is for the single occupier of premises 106 then if the location of mobile device 103 is identified and is determined to be greater than a predefined distance for premises 106 then the energy supplier 102 may trigger the corrective action of turning down or turning off certain devices or appliances in the premises 106 in order to reduce the demand for energy. The energy supplier 102 may trigger the turning off of a device by transmitting commands, via wireless communication channels, wired communication channels, or any combination thereof, to the device to be turned off. The energy supplier 102 may transmit the commands to a smart meter at the premises 106 so that the smart meter can perform or implement the commands received from the energy supplier 102.

Whilst the energy demand remains above the predefined threshold, the energy supplier 102 may periodically identify the location of mobile devices 103, 104, 105.

Therefore, the energy supplier 102 may be able to determine when the location of a mobile device fulfils the criteria associated with the mobile device or with the premises with which the mobile device is associated, even if the criteria were not previously fulfilled.

By periodically identifying the locations of the mobile devices may also enable the energy supplier 102 to determine when, for example, a mobile device is no longer a sufficient distance away from its associated premises and therefore no longer fulfils the criteria predefined for it. In this case, the energy supplier 102 may trigger any devices that were turned down/off to be turned back up/on as the person with the mobile device may be returning to the premises.

The period for periodically identifying the location of the mobile devices 103, 104, 105 may be any period suitable for the purpose, for example, every minute, every 5 minutes, every 10 minutes, every 30 minutes and so on.

Accordingly, many of the embodiments describe a mechanism for an energy supplier to reduce demand on the energy supply by determining whether corrective actions may be triggered at a consumer premises based on, at least in part, the location of mobile devices associated with persons that use the premises. This enables an effective control of the energy demand whilst also maintaining loyalty or business from the consumers.

While preferred embodiments of the invention have been shown and described, it will be understood that such embodiments are described by way of example only. Numerous variations, changes and substitutions will occur to those skilled in the art without departing from the scope of the present invention as defined by the appended claims. Accordingly, it is intended that the following claims cover all such variations or equivalents as fall within the spirit and the scope of the invention.

1. A method, comprising:
determining if energy demand is above a threshold;
determining a location one or more mobile devices if said energy demand is above said threshold, wherein said one or more mobile devices are associated with a premises; and
triggering one or more corrective actions at said premises if said location of said one or more mobile devices are greater than a predefined distance from said premises.

2. The method as claimed in claim 1, in which said energy demand is based on one or both of a current energy demand and a predicted energy demand.

3. The method as claimed in claim 1, in which said step of triggering said one or more corrective actions is further based on one or more predefined first criteria.

4. The method as claimed in claim 1 further comprising:
maintaining a database of said premises and said associated one or more mobile devices.

5. The method as claimed in claim 1 in which said determining if said energy demand is above said threshold further comprises:
determining if said energy demand is above one or more different thresholds.

6. The method as claimed in claim 1, in which said threshold is a variable threshold.

7. The method as claimed in claim 1, in which said determining said location of one or more mobile devices further comprises:
identifying said one or more mobile devices based on one or more predefined second criteria.

8. The method as claimed in claim 1, in which said triggering said one or more corrective actions further comprises:
transmitting a request to one or more devices at said premises wherein said request is to reduce energy consumption is said one or more devices.

9. An apparatus, comprising:
a first processor configured to determine if energy demand is above a threshold;
a second processor configured to determine a location one or more mobile devices if said energy demand is above said threshold, wherein said one or more mobile devices are associated with a premises; and
a third processor configured to trigger one or more corrective actions at said premises if said location of said one or more mobile devices are greater than a predefined distance from said premises.

10. The apparatus as claimed in claim 9, in which said first processor is further configured to determine if energy demand is above said threshold based on one or both of a current energy demand and a predicted energy demand.

11. The apparatus as claimed in claim 9, in which said third processor is further configured to trigger said one or more corrective actions is further based on one or more predefined criteria.

12. The apparatus as claimed in claim 9 further comprising:
a fourth processor configured to maintain a database of said premises and said associated one or more mobile devices.

13. The apparatus as claimed in claim 9 in which said first processor is further configured to:
determine if said energy demand is above one or more different thresholds.

14. The apparatus as claimed in claim 9, further comprising:
a fifth processor configured to identify said one or more mobile devices based on one or more predefined second criteria.

15. The apparatus as claimed in claim 9, further comprising:
an output adapted to transmit a request to one or more devices at said premises wherein said request is to reduce energy consumption is said one or more devices.

16. A computer program product comprising computer readable executable code which, when run on a processor, controls said processor to perform a method comprising:
determining if energy demand is above a threshold;
determining a location one or more mobile devices if said energy demand is above said threshold, wherein said one or more mobile devices are associated with a premises; and
triggering one or more corrective actions at said premises if said location of said one or more mobile devices are greater than a predefined distance from said premises.
